(19) United States
(12) Patent Application Publication
(10) Pub. No.: US 2026/0140991 A1
(43) Pub. Date: May 21, 2026

(54) Scaling to Large Datasets with Runtime Classifier Training

(71) Applicant: MICROSOFT TECHNOLOGY LICENSING, LLC, Redmond, WA (US)

(72) Inventors: Seyedeh Hoda SHAJARI, Redmond, WA (US); Rodrigo CARVALHO REZENDE, Bothell, WA (US); Benjamin David LACKEY, Redmond, WA (US); Jiantao PAN, Lynnwood, WA (US); David Benjamin LEVITAN, Bothell, WA (US); Raieshkumar KOMMU, Redmond, WA (US); Arpan Kumar GHOSH, Redmond, WA (US); Joshua Michael DUNNING, Redmond, WA (US)

(21) Appl. No.: 19/096,667

(22) Filed: Mar. 31, 2025

Related U.S. Application Data
(60) Provisional application No. 63/723,113, filed on Nov. 20, 2024.

(51) Int. Cl. G06F 16/35; G06F 40/20

(52) U.S. Cl. CPC G06F 16/35

(57) ABSTRACT

A dataset is accessed that is to be classified into topics. A subset of the dataset is selected and used to generate themes using a language model. Each item in the subset is classified and labeling into the set of themes using the language model. A classifier model is trained using the classified and labeled subset and the generated themes. The trained classifier model is used to classify the dataset into the set of themes.

### CROSS-REFERENCE TO RELATED APPLICATION

This application claims the benefit of US provisional application number 63/723,113 filed on Nov. 20, 2024, entitled 3-PHASE LLM-BASED DATASET CLUSTERING” the entirety of which is hereby incorporated by reference herein.

### BACKGROUND

Clustering involves identifying patterns or relationships within a dataset that may not be immediately apparent, and grouping similar data points together to better understand the underlying structure of data. In many applications, clustering can be performed using artificial intelligence (AI) models. Language models, such as large language models (LLMs), are a form of AI models within a set of machine learning (ML) models that may be used in various language-intensive tasks, such as clustering of datasets.

When clustering data, for the topic assignment task (matching which item belongs to which topic), it may be necessary to process very large datasets comprising large numbers of text items. Multi-phase clustering schemes provide a way to assign topics in parallel to reduce latency but can face latency and resource costs when dealing with large datasets.

The use of LLMs for clustering large datasets can be expensive (there will be a cost for each LLM call), and latency can be much higher in general compared to traditional methods. Additionally, the context window for each call is limited. When the number of the items reaches large numbers, it may not be possible to fit all of the content into the limited available context window.

One way to address large datasets is to use a parallelized LLM approach that includes dividing data into manageable batches for theme identification, synchronizing and consolidating the results, and assigning dataset items to relevant themes through an additional dividing process. Such LLM-based parallelized clustering allows for separation of topic identification and topic assignment processes, to address the high cost of API calls. However, parallel calls on batched data for topic assignment cannot be increased indefinitely. While multiple layers can be added, each layer adds latency and cost. Classical clustering methods are not well suited to handle large datasets, and algorithms such as HDBScan can leave a high percentage of data unclustered.

It is with respect to these considerations and others that the disclosure made herein is presented.

### SUMMARY

In various embodiments, an LLM is used to generate labeled data for training a classifier that is based on a smaller AI model, such as a binary classification model. The smaller AI model can be run with reduced cost and with greater speed as compared to using the LLM for classification. This smaller AI model is configured to efficiently categorize text items of a large dataset into generated topics. A selected sample set is used to generate topics during the initial topic generation phase using the LLM.

Additionally, methods such as Cosine-similarity can be used to determine the relevance of the positive and negative examples. The sample set and the generated topics can be used to dynamically train the smaller AI model (e.g., classifier) using LLM labeled data. Additional processing such as sentiment and theme assignment can be performed. The disclosed embodiments provide ways to use classifiers without being limited to LLM-powered clustering, while leveraging LLMs to identify the topic set.

The examples described herein are provided within the example context of collaborative computing environments but can be applied in any AI-based environment. Additionally, while many of the illustrated examples use LLMs, it should be noted that other models can be utilized without limiting the scope of the disclosure.

Among many benefits provided by the technologies described herein, a user's interaction with a device may be improved, which may reduce the number of erroneous inputs and outputs, reduce the consumption of processing resources, and mitigate the waste of network resources. Other technical effects other than those mentioned herein can also be realized from implementations of the technologies disclosed herein, including reduced time for clustering, optimizing resource allocation, improved quality, and flexibility.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIG. 1 illustrates an example 2-phase classification scheme.

FIG. 2 illustrates an example 3-phase classification scheme, according to embodiments disclosed herein.

FIG. 3 illustrates an example of a dataset, according to one embodiment disclosed herein.

FIG. 4 illustrates an example process, according to one embodiment disclosed herein.

FIG. 5 is an example illustrating aspects of the embodiments disclosed herein.

FIG. 6 is a computing system diagram showing aspects of an illustrative operating environment for the technologies disclosed herein;

FIG. 7 is a computing system diagram showing aspects of an illustrative operating environment for the technologies disclosed herein;

FIG. 8 is a computing device diagram showing aspects of the configuration and operation of a device that can implement aspects of the disclosed technologies, according to one embodiment disclosed herein.

FIG. 9 is a computing system diagram showing aspects of an illustrative operating environment for the technologies disclosed herein;

FIG. 10 illustrates aspects of a routine, according to one embodiment disclosed herein;

FIG. 11 is a computing system diagram showing aspects of an illustrative operating environment for the technologies disclosed herein;

FIG. 12 is a computing device diagram showing aspects of the configuration and operation of a device that can implement aspects of the disclosed technologies, according to one embodiment disclosed herein.

FIG. 13 is an example functional diagram illustrating aspects of classification according to embodiments disclosed herein.

### DETAILED DESCRIPTION

The advent of language models such as large language models (LLMs) has revolutionized various domains of artificial intelligence, particularly in natural language processing (NLP) and text analysis. Text analysis is the process and technology to automatically analyze unstructured text data and extract insights or information. As used herein, text analysis generally refers to collections of short text, e.g., survey responses, reviews, tickets, bugs, service requests, social media, etc. Some embodiments allow for single-column processing, including many-to-one (summarization) and one-to-one (tagging) capabilities. In many computing environments, users need to identify themes in text data and categorize each data item into relevant themes. As used herein, a theme is an overarching concept that characterizes a group of similar text data.

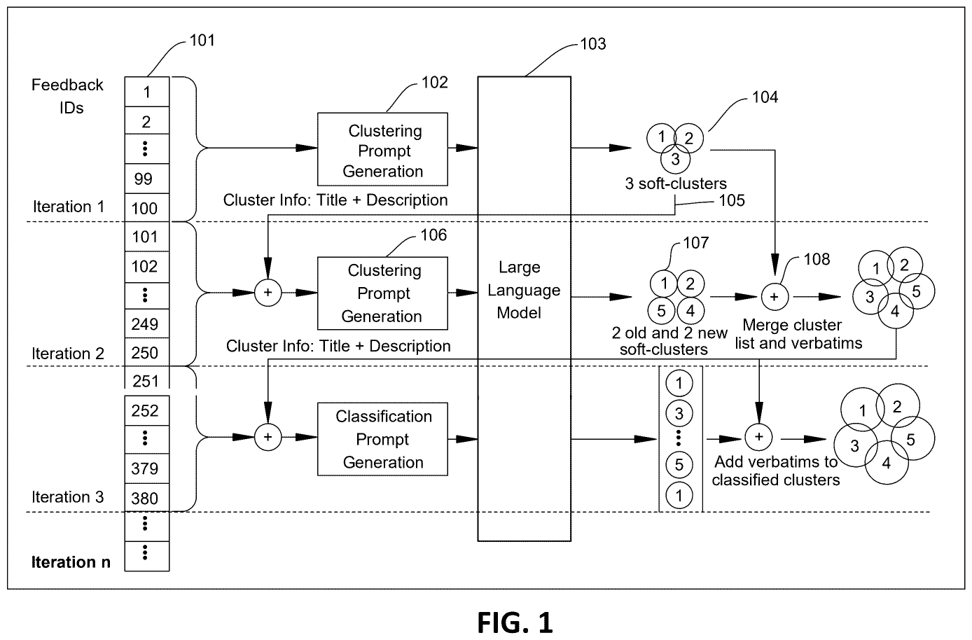

LLM-based clustering techniques leverage the capabilities of these models to group data into meaningful clusters, particularly when dealing with textual information. The goal of clustering is to identify patterns or relationships within a dataset that may not be immediately apparent. Clustering involves grouping similar data points together based on their attributes and characteristics to better understand the underlying structure of data. FIG. 1 illustrates an example of iterative LLM-based clustering with persistent cache mechanisms. Feedback elements 101 are input to a clustering prompt generation process 102. The output of the clustering prompt generation process 102 is input to LLM 103 to generate clusters 104. The clusters 104 are then used for another iteration of the clustering prompt generation process 106 that is input to the LLM 103. The next output set of clusters 107 are merged 108 with the previously output clusters 104.

A 2-phase clustering approach (described in US Patent Application entitled “DATASET CLUSTERING AND EVALUATION” Application No.: 500829-US01 filed Mar. 25, 2024, the contents of which are incorporated by reference herein), provides a way to assign topics using LLMs.

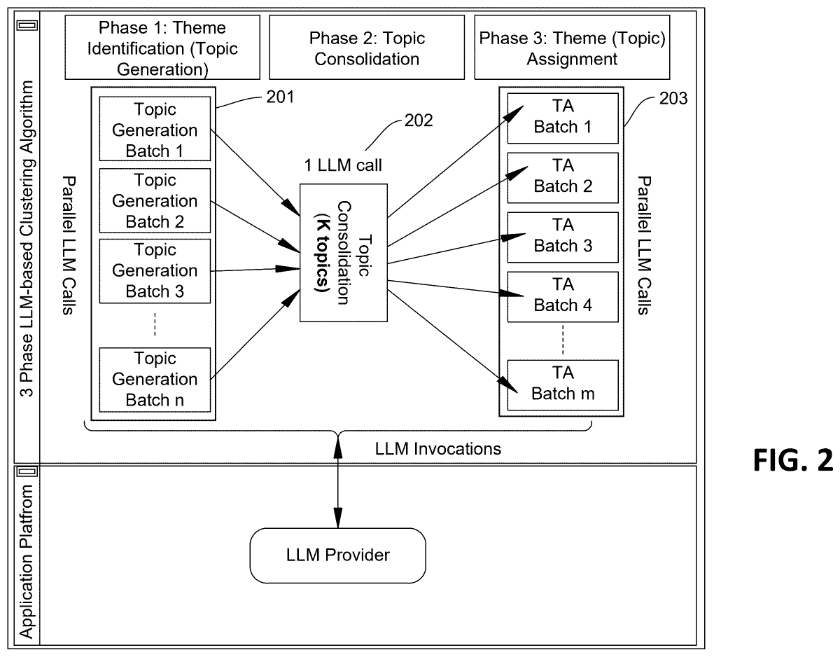

A 3-phase LLM-based clustering approach (described in US Patent Application entitled “3-PHASE DATASET CLUSTERING”Application No.: Ser. No. 19/080,834 filed Mar. 15, 2025, the contents of which are incorporated by reference herein), provides a way to assign topics in parallel to reduce latency. FIG. 2 illustrates an example of a parallelized 3-phase LLM-based clustering approach. In this example, phase 2 (topic consolidation) 202 of the algorithm illustrates making only one LLM call to merge topics after all the LLM invocations for phase 1 are completed based on topic generation batches 201. The single LLM call 202 generates TA batches 203.

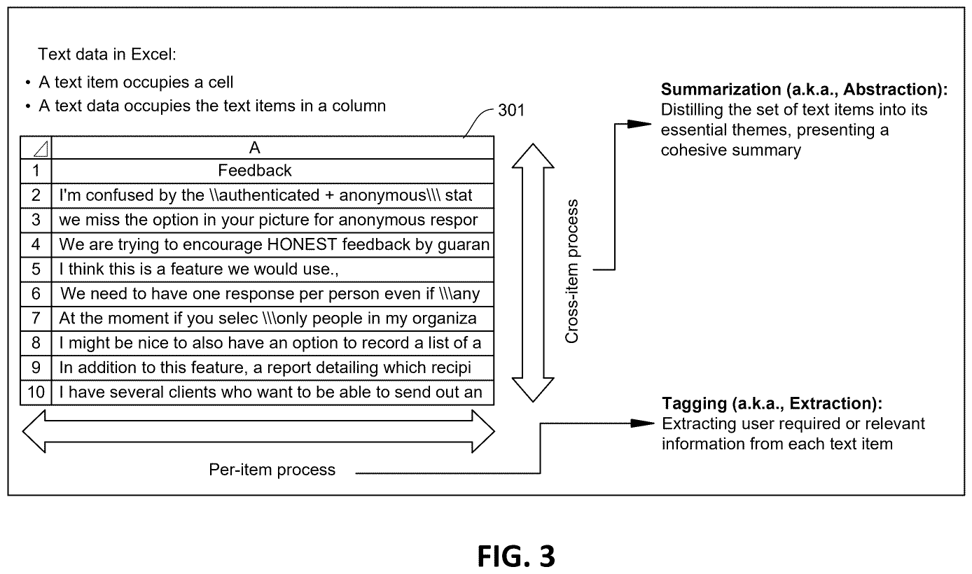

FIG. 3 illustrates examples of text analysis for text data in a spreadsheet, where a text item occupies a cell, and text data occupies the text items in a column 301. Summarization (or abstraction) is a cross-item process that includes distilling the set of text items into essential themes, and presenting a cohesive summary. Tagging (or extraction) is a per-item process that includes extracting information from each text item.

Although the above approaches can generally be effective in generating quality clustering results, such approaches have some drawbacks. One of the drawbacks is their inability to efficiently address large datasets. When clustering data, for topic assignment (matching which item belongs to which topic), it may be necessary to process very large datasets comprising large numbers of text items.

The 3-phase clustering approach can scale to a certain threshold which, for an LLM-based approach, can depend on the size of the LLM model's context window (e.g., 128K), but may face latency and resource costs depending on the particular application or context (e.g., an AI chat vs. large scale processing of massive datasets). LLMs can be expensive (there will be a cost for each LLM call), and latency for LLMs can be much higher than other approaches. Furthermore, the content window for each call is limited. When the number of the items reaches threshold numbers, the amount of available threads may not fit all the content into the limited context windows. Additional factors include the number of parallel threads (related to the cost of LLM API calls) and latency considerations for certain scenarios, such as real-time chat experiences, where LLM calls remain relatively slow despite parallelization efforts.

The present disclosure provides techniques that leverage features of the various approaches described above in the case of large datasets. In various embodiments, an LLM is used to train a simpler and more efficient classifier that is based on a smaller AI model that can be run without additional cost and with greater speed. The speed of such smaller AI models can be many times faster than an LLM call. The smaller AI model is configured to efficiently categorize the text items of a large dataset into the generated topics.

In one embodiment, a sample set of a larger dataset can be selected to be processed by an LLM to generate topics, during the initial topic generation phase. In the next phase, the sampled data is classified by the LLM to the previously identified topics (labels). The labeled sample set and the generated topics can be used to train a smaller AI model, such as a binary classification model. In some embodiments, the selection of the data is performed by a selection function, or can be performed by the LLM. As used herein, a smaller AI model refers to models that incorporate aspects of AI techniques but incorporate less features in order to be more efficient at a particular task (e.g., a binary classifier or small language model (SLM)) as opposed to a more generalized AI model such as an LLM.

One method for selecting a subset of data for this phase is random sampling. Depending on the particular objectives, other approaches can be used such as stratified sampling. Each sample can have ‘x’ number of items. The sample size can be determined and adjusted by the number of LLM invocations, the given number of topics to be extracted, the desired granularity level of the themes, etc.

In various embodiments, LLMs can identify topics, and generate high quality clusters with labeled data for a smaller set of data. This subset of the data with high quality labels, and optionally with some negative samples generated by the LLM, can then be used to train the smaller and faster model. The subset of the data is used to train and perform inferencing with the smaller AI models, with a smaller memory footprint, which can yield suitable results for their specialized classification task. These classifiers using smaller models can be run in parallel. For example, each model can be trained on one topic and determine if a text item belongs within that topic. The results can be scaled to very large datasets, for example datasets exceeding one million items. The run time cost and latency can be approximately equivalent to, in one example (time for 2 LLM calls for divide conquer+parallel model training+1 parallel smaller model call).

In one embodiment, unsupervised text clustering, or supervised text analysis that does not require user intervention, can be implemented. Supervised learning that requires extensive labeling can be cumbersome and can be susceptible to training data and human errors. Additionally, keyword-based theming can cause confusion, and requires a comprehensive design of base themes.

In one embodiment, an unsupervised clustering workﬂow can include starting with raw verbatim, applying clustering, and adjusting a slider for sensitivity. In some embodiments, clusters can be named. In one embodiment, keyword based theming suggestions are generated, and the keywords are added to theming. A sensitivity slider can be an adjustable control that controls how clusters are formed or how sensitive the clustering algorithm is to variations in the data.

In one embodiment, unsupervised clustering results are input to a supervised ML model. This will provide a workﬂow that allows users to quickly identify theming clusters, and preserve those clusters for supervised machine learning. In one embodiment, modified unsupervised clustering may be implemented that may require some model updates.

In one embodiment, a workflow can include:
Start with a base of raw verbatim
Perform unsupervised clustering, and generate initial clusters
Adjust a sensitivity slider
Inspect clusters and finalize initial clusters
Label each cluster
For outliers, the model can adjust special verbatim items into desired clusters.
Preserve model and results
Collect a predetermined number of days/weeks/months of new verbatim
For each new verbatim:
   Put them into original named clusters
   Dynamically adjust cluster parameters without a full retrain
   Performing visualization, trending, and new topic detection

In an embodiment, when an LLM detects a new topic while processing an incoming batch of data, the LLM may trigger a new workflow so that a new classifier for the new topic is prepared.

Cluster labels can be noisy, leading to poorly trained classifiers. One source of the noise is the iterative process of generating cluster labels. In one embodiment, a process is performed to clean the noisy labels and train classifiers using embeddings and a classification

algorithm for binary or multi-class classification, such as logistic regression, on the denoised labels. In some embodiments, all examples in the dataset obtain their cluster labels from a final zero-shot LLM classifier to prevent noisy (inconsistent) cluster labels.

An advantage of using smaller classifiers is that they can be made durable and persisted, where the trained classifier can be saved and reused over time. This enables efficient reuse of resources and avoids redundant training. This applies to scenarios such as long-running surveys, and more generally to systems that need to trend over time. The smaller classifier

models are trained and preserved as a durable asset, which is useful to reduce the LLM burden when a new batch of data comes in.

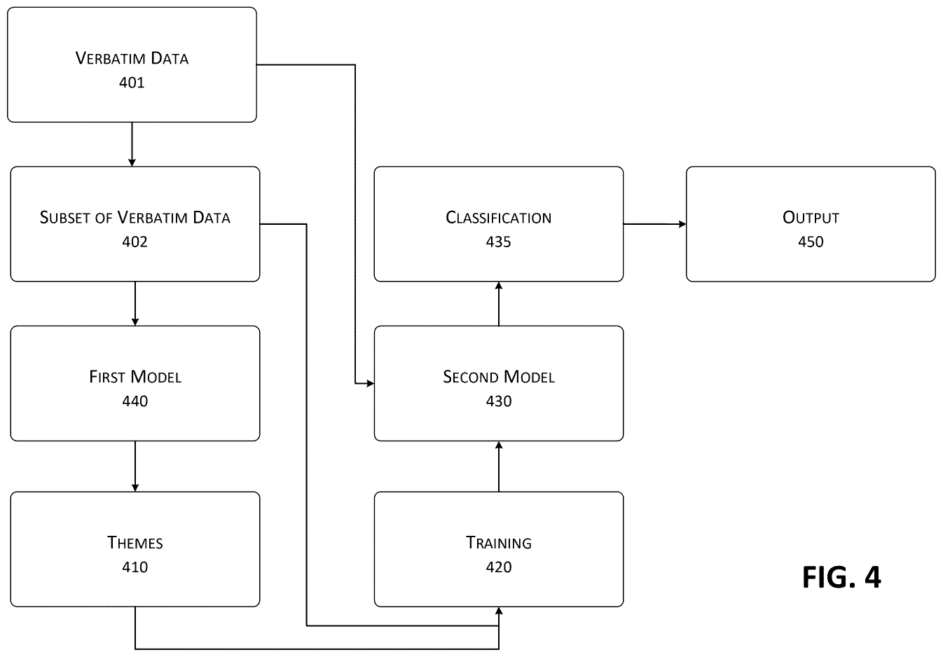

With reference to FIG. 4, illustrated is an example system for clustering data in accordance with the disclosure. In an embodiment, a computing system accesses a set of data to be classified into topics. Based on the verbatim data 401, a subset of the verbatim data is selected 402. A first artificial intelligence (AI) model 440 is used to generate a set of themes 410. The generated themes and the subset of the verbatim data are used to train 420 a second AI model 430. Once trained, the AI model 430 is used to classify 435 each item in the verbatim data 401. An output 450 is generated identifying which items of the set of data are classified into which themes of the set of themes.

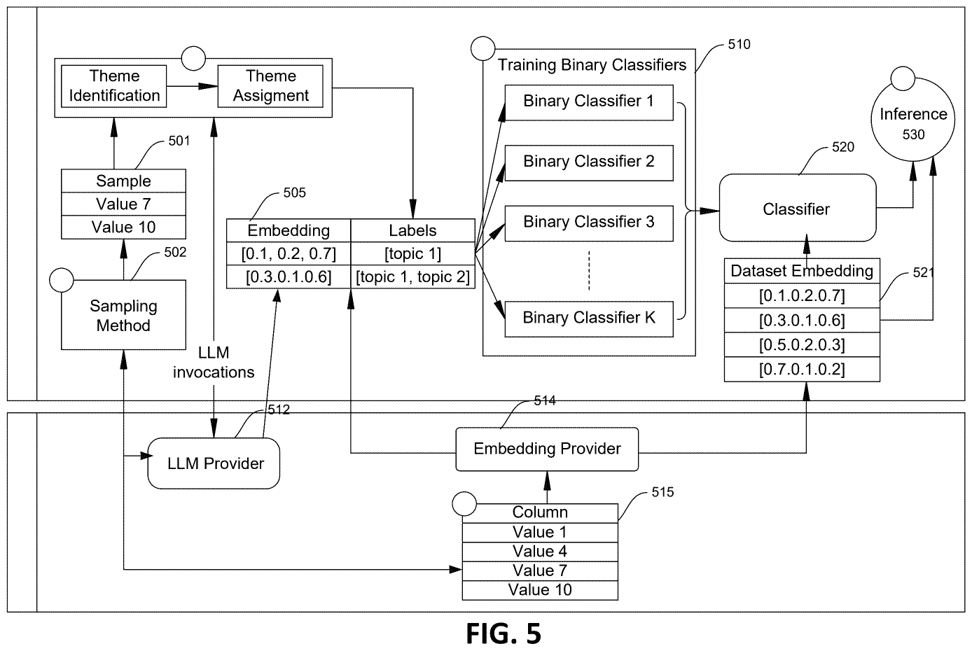

With reference to FIG. 5, illustrated is an example system for clustering data using trained models in accordance with the disclosure. FIG. 5 illustrates an example of dynamically training a classifier using LLM labeled data. Binary classifiers 510 are trained on a small/medium size subset 501 of a larger dataset using a sampling method 502 to produce labeled data with embeddings 505. In some embodiments, an LLM provider 512 receives the small/medium size subset 501 and generates topics. An embedding provider or function 514 generates embeddings for data items in the large dataset 515 and/or the samples 501. The binary classifiers 510 are trained using the LLM-labeled data and the generated topics to classify the labeled data. In some embodiments, the binary classifiers 510 are implemented as a general classifier 520. In one example, the binary classifiers 510 can each be trained on one theme and determine if each input label is classified in the theme. In some embodiments, each labeled data item can be input to each of the binary classifiers. The binary classifiers 510 with or along with classifier 520 are used for inferencing 530 of the dataset embeddings 521.

As used herein, “AI” refers to the use of computing systems to perform intelligent tasks such as language processing, analysis, and problem solving. Examples of a model utilizing AI include a Large Language Model (LLM). Although many examples in the present disclosure are illustrated using LLMs, it should be understood that the disclosure can be implemented using other models. For example, the described techniques can be performed by any other language model or NLP technique including but not limited to using embeddings and a similarity metric for merging topics. In some embodiments, the language model can be replaced using an embedding and some similarity metric for topic consolidation, for example. Additionally, although many examples in the present disclosure are illustrated using AI-based systems, it should be noted that the disclosed embodiments can be implemented in systems that do not interact with or incorporate AI-based systems and technologies. More generally, language models is a general term and can refer to any current or future language model. It is possible to change or make modifications to the prompts to ask the language models for additional information or perform an additional task including but not limited to:
assigning a sentiment to each document/datapoint
prompting the language model to generate a summary of each cluster instead of or in addition to a short description for each cluster
prompting the language model to generate broad or granular clusters by changing the range of generated titles
prompting the language model to generate hierarchical clustering.

For topic/theme assignment step, the language model can be prompted to perform other evaluation tasks such as assigning a probability to each item in the cluster which reflects the confidence of the language model for the assignments. The language model can be asked to explain why it has generated a title/topic or reason pertaining to the logic of the consolidation of topics. The language model can also be asked to reason why it has assigned an item to a title (topic/theme). The disclosed embodiments can provide support for non-English languages by analyzing data in any language or the cases for datasets with multiple languages and generate the results in any language.

Regarding the figures (which might be referred to herein as a “FIG.” or “FIGS.”), additional details will be provided with reference to the accompanying drawings. The figures show, by way of illustration, specific configurations or examples. Like numerals represent like or similar elements throughout the FIGS. References made to individual items of a plurality of items can use a reference number with another number included within a parenthetical (and/or a letter without a parenthetical) to refer to each individual item. Generic references to the items might use the specific reference number without the sequence of letters. The drawings are not drawn to scale.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

It should be appreciated that various aspects of the subject matter described briefly above and in further detail below can be implemented as a hardware device, a computer-implemented method, a computer-controlled apparatus or device, a computing system, or an article of manufacture, such as a computer storage medium. While the subject matter described herein is presented in the general context of program modules that execute on one or more computing devices, those skilled in the art will recognize that other implementations can be performed in combination with other types of program modules. Generally, program modules include routines, programs, components, data structures, and other types of structures that perform particular tasks or implement particular abstract data types.

Those skilled in the art will also appreciate that aspects of the subject matter described herein can be practiced on or in conjunction with other computer system configurations beyond those specifically described herein, including multiprocessor systems, microprocessor-based or programmable consumer electronics, AR, VR, and MR devices, video game devices, handheld computers, smartphones, smart televisions, self-driving vehicles, smart watches, e-readers, tablet computing devices, special-purpose hardware devices, network appliances, and the others.

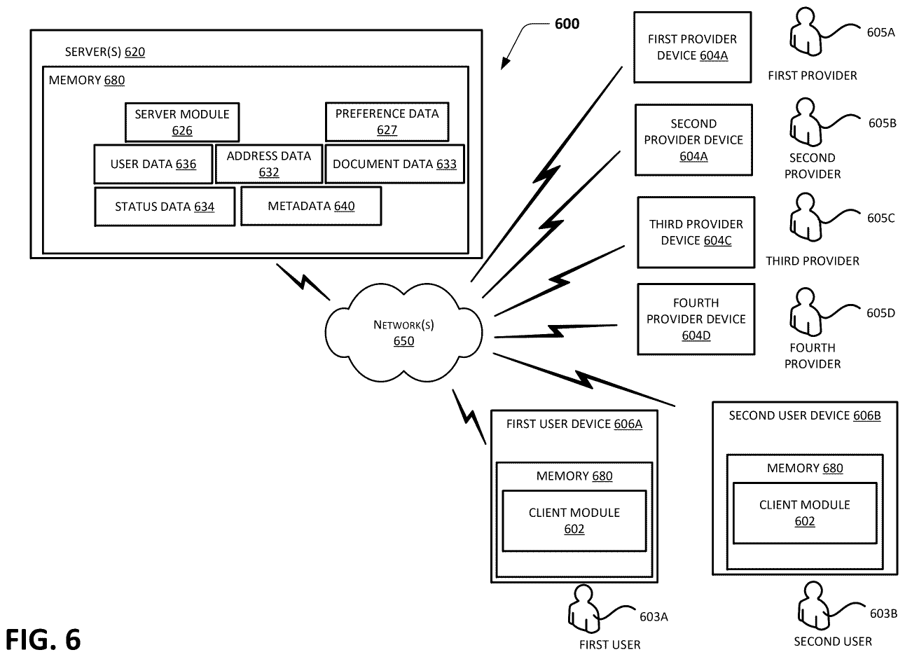

FIG. 6 is a block diagram showing aspects of one example environment 600, also referred to herein as a “system 600,” disclosed herein for clustering data. In one illustrative example, the example environment 600 can include one or more servers 620, one or more networks 650, one or more user devices 606A-606B (collectively “user devices 606”), one or more provider devices 604A-604D (collectively “provider devices 604”), and one or more resources 606A-606E (collectively “resources 606”). The user devices 606 can be utilized for interaction with one or more users 603A-603B (collectively “users 603”), and the provider devices 604 can be utilized for interaction with one or more service providers 605A-605D (collectively “service providers 605”). This example is provided for illustrative purposes and is not to be construed as limiting. It can be appreciated that the example environment 600 can include any number of devices, users, providers, and/or any number of servers 620.

For illustrative purposes, the service providers 605 can be a company, person, or any type of entity capable of providing services or products for the users 603, which can also be a company, person or other entity. For illustrative purposes, the service providers 605 and the users 603 can be generically and individually referred to herein as “users.” In some configurations, a data object may include one or more messages. Contextual data can be analyzed to determine one or more messages that can be updated dynamically.

The user devices 606, provider devices 604, servers 620 and/or any other computer configured with the features disclosed herein can be interconnected through one or more local and/or wide area networks, such as the network 650. In addition, the computing devices can communicate using any technology, such as BLUETOOTH, WIFI, WIFI DIRECT, NFC or any other suitable technology, which may include light-based, wired, or wireless technologies. It should be appreciated that many more types of connections may be utilized than described herein.

A user device 606 or a provider device 604 (collectively “computing devices”) can operate as a stand-alone device, or such devices can operate in conjunction with other computers, such as the one or more servers 620. Individual computing devices can be in the form of a personal computer, mobile phone, tablet, wearable computer, including a head-mounted display (HMD) or watch, or any other computing device having components for interacting with one or more users and/or remote computers. In one illustrative example, the user device 606 and the provider device 604 can include a local memory 680, also referred to herein as a “computer-readable storage medium” or “non-transitory computer-readable storage medium” configured to store data, such as a client module 602 and other contextual data described herein.

The servers 620 may be in the form of a personal computer, server farm, large-scale system or any other computing system having components for processing, coordinating, collecting, storing, and/or communicating data between one or more computing devices. In one illustrative example, the servers 620 can include a local memory 680, also referred to herein as a “computer-readable storage medium,” configured to store data, such as a server module 626 and other data described herein. The servers 620 can also include components and services, such as the application services and shown in FIG. 6, for providing, receiving, and processing data and executing one or more aspects of the techniques described herein. As will be described in more detail herein, any suitable module may operate in conjunction with other modules or devices to implement aspects of the techniques disclosed herein.

In some configurations, an application programming interface (API) exposes an interface through which an operating system and application programs executing on the computing device can enable the functionality disclosed herein. Through the use of this data interface and other interfaces, the operating system and application programs can communicate and process contextual data and modify scheduling data as described herein.

The user data 636 can include various data for the users 603 and the providers 605. The user data 636 can include communication information such as a email address, job title, or other information. The user data 636 can be stored on the server 620, user device 606, provider device 604, or any suitable computing device, which may include a Web-based service.

The address data 632 may include address information for the user's contacts. The address data 632 can also be based on user data 636. These examples are provided for illustrative purposes and are not to be construed as limiting. The preference data 627 can include user-defined preferences or provider-defined preferences. Other data can include document data 633, status data 634, and metadata 640.

To enable aspects of the techniques disclosed herein, one or more computing devices of FIG. 6 can be configured to generate data defining one or more live updates in response to detecting the presence of a condition. The implementations can include obtaining contextual data from a plurality of resources.

One or more computing devices can be configured to identify a pattern of the contextual data indicating a presence of a condition that affects one or more aspects of the data.

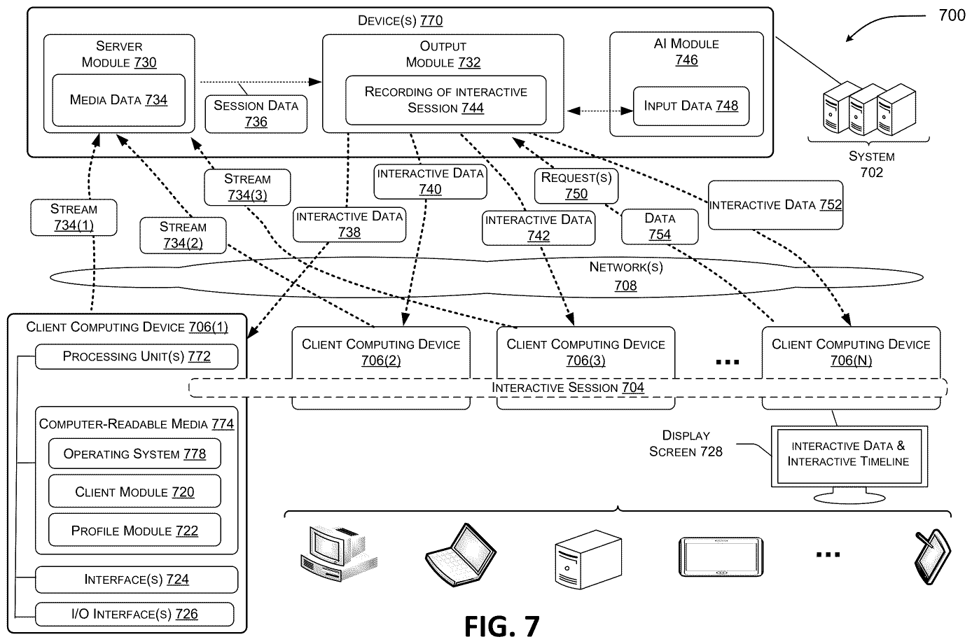

FIG. 7 is a diagram illustrating an example environment 700 in which a system can operate to generate information for an interactive session 704 and to save and edit content. In this example, an interactive session 704 is implemented between a number of client computing devices 706(7) through 706(N) (where N is a positive integer number having a value of two or greater). The client computing devices 706(7) through 706(N) enable users to participate in the interactive session 704. In this example, the interactive session 704 is hosted, over one or more network(s) 708, by the system 702. That is, the system 702 can provide a service that enables users of the client computing devices 706(7) through 706(N) to participate in the interactive session 704 (e.g., via a live viewing and/or a recorded viewing). Consequently, a “participant” to the interactive session 704 can comprise a user and/or a client computing device (e.g., multiple users may be in a conference room participating in a interactive session via the use of a single client computing device), each of which can communicate with other participants. As an alternative, the interactive session 704 can be hosted by one of the client computing devices 706(7) through 706(N) utilizing peer-to-peer technologies.

In examples described herein, client computing devices 706(7) through 706(N) participating in an interactive session 704 are configured to receive and render for display, on a user interface of a display screen, interactive data. The interactive data can comprise a collection of various instances, or streams, of content. For example, an individual stream of content can comprise media data associated with a video feed (e.g., audio and visual data that capture the appearance and speech of a user participating in the interactive session). Another example of an individual stream of content can comprise media data that includes a file displayed on a display screen along with audio data that captures the speech of a user. Accordingly, the various streams of content within the teleconference data enable a remote meeting to be facilitated between a group of people and the sharing of content within the group of people.

The system 702 includes device(s) 770. The device(s) 770 and/or other components of the system 702 can include distributed computing resources that communicate with one another and/or with the client computing devices 706(7) through 706(N) via the one or more network(s) 708. In some examples, the system 702 may be an independent system that is tasked with managing aspects of one or more interactive sessions such as interactive session 704. As an example, the system 702 may be managed by entities such as SLACK, WEBEX, GOTOMEETING, GOOGLE HANGOUTS, etc.

Network(s) 708 may include, for example, public networks such as the Internet, private networks such as an institutional and/or personal intranet, or some combination of private and public networks. Network(s) 708 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 708 may utilize communications protocols, including packet-based and/or datagram-based protocols such as Internet protocol (“IP”), transmission control protocol (“TCP”), user datagram protocol (“UDP”), or other types of protocols. Moreover, network(s) 708 may also include a number of devices that facilitate network communications and/or form a hardware basis for the networks, such as switches, routers, gateways, access points, firewalls, base stations, repeaters, backbone devices, and the like.

In some examples, network(s) 708 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.77 standards (e.g., 802.77g, 802.77n, and so forth), and other standards.

In various examples, device(s) 770 may include one or more computing devices that operate in a cluster or other grouped configuration to share resources, balance load, increase performance, provide fail-over support or redundancy, or for other purposes. For instance, device(s) 770 may belong to a variety of classes of devices such as traditional server-type devices, desktop computer-type devices, and/or mobile-type devices. Thus, although illustrated as a single type of device—a server-type device—device(s) 770 may include a diverse variety of device types and are not limited to a particular type of device. Device(s) 770 may represent, but are not limited to, server computers, desktop computers, web-server computers, personal computers, mobile computers, laptop computers, tablet computers, or any other sort of computing device.

A client computing device (e.g., one of client computing device(s) 706(7) through 706(N)) (each of which are also referred to herein as a “data processing system”) may belong to a variety of classes of devices, which may be the same as, or different from, device(s) 770, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 706(7) through 706(N) of the various classes and device types can represent any type of computing device having one or more processing unit(s) 772 operably connected to computer-readable media 774 via a bus which in some instances can include one or more of a system bus, a data bus, an address bus, a PCI bus, a Mini-PCI bus, and any variety of local, peripheral, and/or independent buses.

Executable instructions stored on computer-readable media 774 may include, for example, an operating system 778, a client module 720, a profile module 722, and other modules, programs, or applications that are loadable and executable by processing units(s) 772.

Client computing device(s) 706(7) through 706(N) may also include one or more interface(s) 724 to enable communications between client computing device(s) 706(7) through 706(N) and other networked devices, such as device(s) 770, over network(s) 708. Such network interface(s) 724 may include one or more network interface controllers (NICs) or other types of transceiver devices to send and receive communications and/or data over a network. Moreover, a client computing device 706(7) can include input/output (“I/O”) interfaces 726 that enable communications with input/output devices such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 70 illustrates that client computing device 706(N) is in some way connected to a display device (e.g., a display screen 728), which can display the interactive timeline for the interactive session 704, as shown.

In the example environment 700 of FIG. 70, client computing devices 706(7) through 706(N) may use their respective client modules 720 to connect with one another and/or other external device(s) in order to participate in the interactive session 704. For instance, a first user may utilize a client computing device 706(7) to communicate with a second user of another client computing device 706(2). When executing client modules 720, the users may share data, which may cause the client computing device 706(7) to connect to the system 702 and/or the other client computing devices 706(2) through 706(N) over the network(s) 708.

The client computing device(s) 706(7) through 706(N) may use their respective profile module 722 to generate participant profiles and provide the participant profiles to other client computing devices and/or to the device(s) 770 of the system 702. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for interactive sessions.

As shown in FIG. 70, the device(s) 770 of the system 702 includes a server module 730 and an output module 732. The server module 730 is configured to receive, from individual client computing devices such as client computing devices 706(7) through 706(3), media streams 734(7) through 734(3). As described above, media streams can comprise a video feed (e.g., audio and visual data associated with a user), audio data which is to be output (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 730 is configured to receive a collection of various media streams 734(7) through 734(3) (the collection being referred to herein as media data 734). In some scenarios, not all the client computing devices that participate in the interactive session 704 provide a media stream. For example, a client computing device may only be a consuming, or a “listening”, device such that it only receives content associated with the interactive session 704 but does not provide any content to the interactive session 704.

The server module 730 is configured to generate session data 736 based on the media data 734. In various examples, the server module 730 can select aspects of the media data 734 that are to be shared with the participating client computing devices 706(7) through 706(N). Consequently, the server module 730 is configured to pass the session data 736 to the output module 732 and the output module 732 may communicate teleconference data to the client computing devices 706(7) through 706(3). As shown, the output module 732 transmits teleconference data 738 to client computing device 706(7), transmits teleconference data 740 to client computing device 706(2), and transmits interactive data 742 to client computing device 706(3). The interactive data transmitted to the client computing devices can be the same or can be different (e.g., positioning of streams of content within a user interface may vary from one device to the next). The output module 732 is also configured to record the interactive session (e.g., a version of the interactive data) and to maintain a recording of the interactive session 744.

The device(s) 770 can also include an AI module 746, and in various examples, the AI module 746 is configured to manage input data 748 in the session data 736 and/or events relevant to interactive session 744.

A client computing device such as client computing device 706(N) can provide a request 750 to view a recording of the interactive session 704. In response, the output module 732 can provide interactive data and interactive data 752 to be displayed on a display screen 728 associated with the client computing device 706(N). The teleconference data transmitted to client computing device 706(N) comprises previously recorded content of the interactive session 704. As further described herein, a user of client computing device 706(N) can provide input(s) to add supplemental recorded content to the interactive session 704 and/or to the interactive timeline, and data 754 associated with the supplemental recorded content can be transmitted from client computing device 706(N) to the system 702 so that the recording of the interactive session 744 and the interactive timeline can be updated with the supplemental recorded content. This enables other participants (e.g., users of client computing devices 706(7) through 706(3)) to consume or view the supplemental recorded content after the live viewing of the interactive session has already ended. An improved human-computer interface (“HCl”) is disclosed herein for interacting with representations of data and data content. In some embodiments, the data may be presented in conjunction with a communications platform such as a videoconferencing platform. Such a system may be referred to as an interactive system.

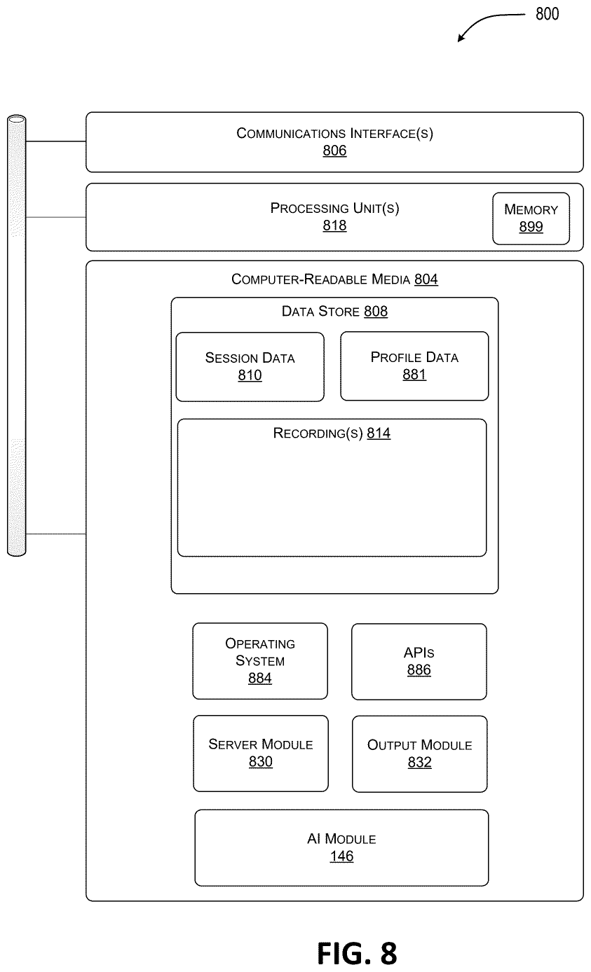

FIG. 8 illustrates a diagram that shows example components of an example device 800 configured to render and update data. The device 800 may represent one of device(s) 706, or in other examples a client computing device (e.g., client computing device 706(1)), where the device 800 includes one or more processing unit(s) 818, computer-readable media 804, and communication interface(s) 806. The components of the device 800 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 818 and/or processing unit(s) 818, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 804, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 806 may represent, for example, network interface controllers (“NICs”) or other types of transceiver devices to send and receive communications over a network.

In the illustrated example, computer-readable media 804 includes a data store 808. In some examples, data store 808 includes data storage such as a database, data warehouse, or other type of structured or unstructured data storage. In some examples, data store 808 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 808 may store data for the operations of processes, applications, components, and/or modules stored in computer-readable media 804 and/or executed by processing unit(s) 818 and/or accelerator(s). For instance, in some examples, data store 808 may store session data 810 (e.g., session data 736), profile data 881 (e.g., associated with a participant profile), and/or other data. The session data 810 can include a total number of participants (e.g., users and/or client computing devices) in the interactive session 704, and activity that occurs in the interactive session 704, and/or other data related to when and how the interactive session 704 is conducted or hosted. The data store 808 can also include recording(s) 814 of interactive session(s).

Alternately, some or all of the above-referenced data can be stored on separate memories 899 on board one or more processing unit(s) 818 such as a memory on board a CPU-type processor, a GPU-type processor, an FPGA-type accelerator, a DSP-type accelerator, and/or another accelerator. In this example, the computer-readable media 804 also includes operating system 884 and application programming interface(s) 886 configured to expose the functionality and the data of the device 800 to other devices. Additionally, the computer-readable media 804 includes one or more modules such as the server module 830, the output module 832, and the AI module 146, although the number of illustrated modules is just an example, and the number may vary higher or lower. That is, functionality described herein in association with the illustrated modules may be performed by a fewer number of modules or a larger number of modules on one device or spread across multiple devices.

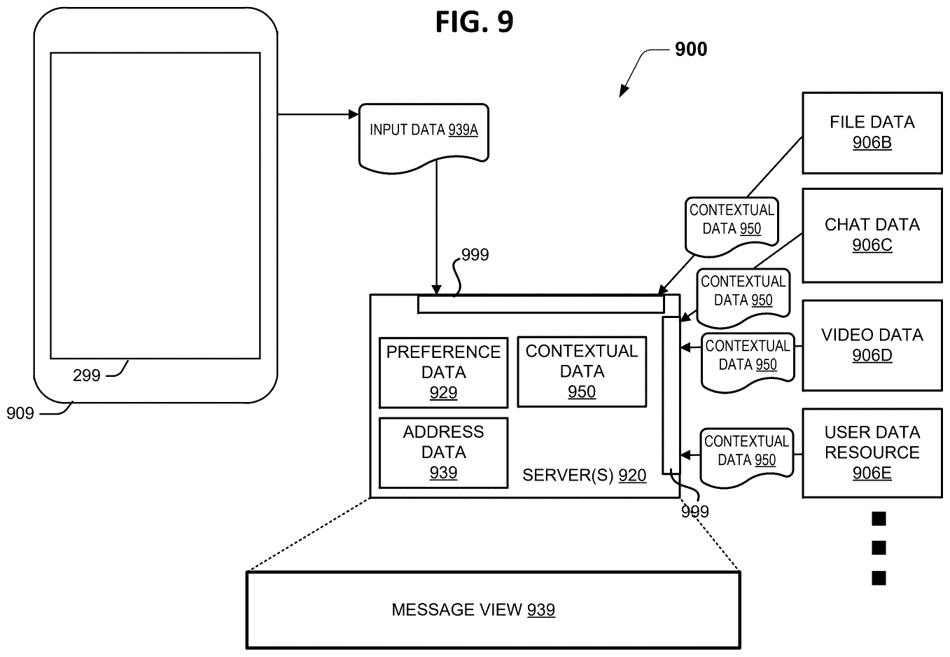

FIG. 9 illustrates aspects of the system 900 that provide a framework for several example scenarios utilizing the techniques disclosed herein. More specifically, this block diagram of the system 900 shows an illustrative example of the server 920 receiving input data 939A defining a user input. The server 920 is also storing input data 939A defining a number of inputs for a user and preference data 929. The server 920 also receives contextual data 950 from a number of resources 906A-906E, as well as other resources described herein. To illustrate aspects of the examples described below, the user device 909 is displaying a user interface (UI) 299 showing a message view.

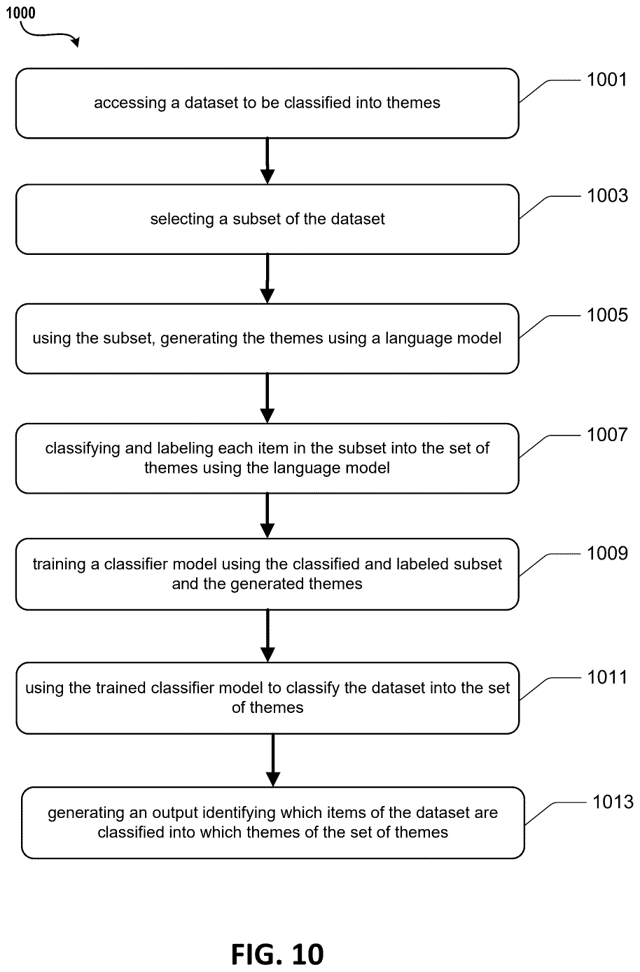

FIG. 10 is a diagram illustrating aspects of a routine 1000 according to one embodiment disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 10 and the other FIGS. can be implemented in association with the example systems described above with respect to FIGS. 1 through 9.

Referring to FIG. 10, operation 1001 illustrates accessing a dataset to be classified into themes, the dataset comprising a plurality of text statements and the themes comprising a concept that characterizes a group of text data.

Operation 1003 illustrates selecting a subset of the dataset.

Operation 1005 illustrates using the subset, generating the themes using a language model.

Operation 1007 illustrates classifying and labeling each item in the subset into the set of themes using the language model.

Operation 1009 illustrates training a classifier model using the classified and labeled subset and the generated themes.

Operation 1011 illustrates using the trained classifier model to classify the dataset into the set of themes.

Operation 1013 illustrates generating an output identifying which items of the dataset are classified into which themes of the set of themes.

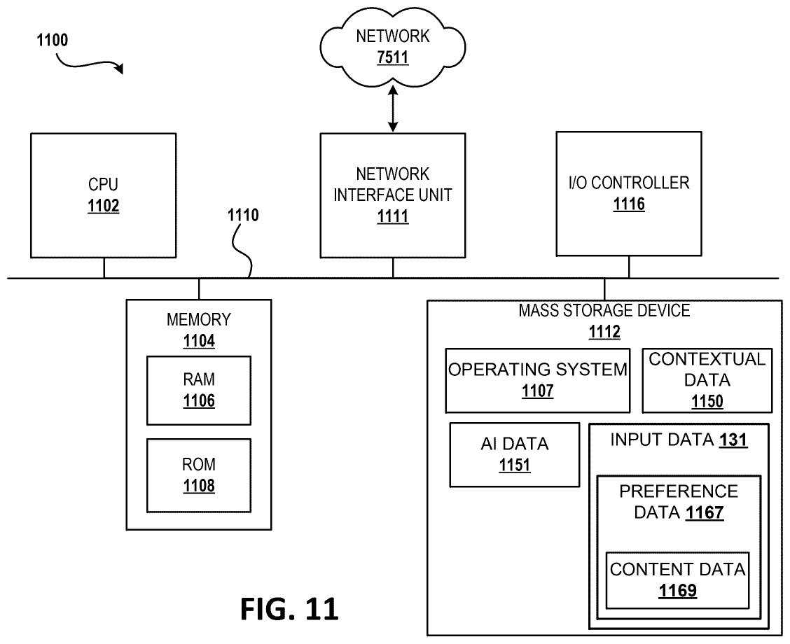

FIG. 11 shows additional details of an example computer architecture 1100 for a computer, such as any of the computing devices depicted in FIGS. 1-10, capable of executing the program components described herein. Thus, the computer architecture 1100 illustrated in FIG. 11 illustrates an architecture for a server computer, mobile phone, a PDA, a smart phone, a desktop computer, a netbook computer, a tablet computer, and/or a laptop computer. The computer architecture 1100 may be utilized to execute any aspects of the software components presented herein.

The computer architecture 1100 illustrated in FIG. 11 includes a central processing unit 1102 (“CPU”), a system memory 1104, including a random access memory 1106 (“RAM”) and a read-only memory (“ROM”) 1108, and a system bus 1110 that couples the memory 1104 to the CPU 1102. A basic input/output system containing the basic routines that help to transfer information between elements within the computer architecture 1100, such as during startup, is stored in the ROM 1108. The computer architecture 1100 further includes a mass storage device 1112 for storing an operating system 1107, data, such as the contextual data 1150, AI data 1151, input data 131, preference data 1167, content data 1169, and one or more application programs (not depicted in FIG. 11).

The mass storage device 1112 is connected to the CPU 1102 through a mass storage controller (not shown) connected to the bus 1110. The mass storage device 1112 and its associated computer-readable media provide non-volatile storage for the computer architecture 1100. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 1100.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1100. For purposes the claims, the phrase “computer storage medium,” “computer-readable storage medium” and variations thereof, does not include waves, signals, and/or other transitory and/or intangible communication media, per se.

According to various configurations, the computer architecture 1100 may operate in a networked environment using logical connections to remote computers through the network 7511 and/or another network (not shown). The computer architecture 1100 may connect to the network 7511 through a network interface unit 1111 connected to the bus 1110. It should be appreciated that the network interface unit 1111 also may be utilized to connect to other types of networks and remote computer systems. The computer architecture 1100 also may include an input/output controller 1116 for receiving and processing input from a number of other devices, including a keyboard, mouse, or electronic stylus (not shown in FIG. 11). Similarly, the input/output controller 1116 may provide output to a display screen, a printer, or other type of output device (also not shown in FIG. 11).

It should be appreciated that the software components described herein may, when loaded into the CPU 1102 and executed, transform the CPU 1102 and the overall computer architecture 1100 from a general-purpose computing system into a special-purpose computing system customized to facilitate the functionality presented herein. The CPU 1102 may be constructed from any number of transistors or other discrete circuit elements, which may individually or collectively assume any number of states. More specifically, the CPU 1102 may operate as a finite-state machine, in response to executable instructions contained within the software modules disclosed herein. These computer-executable instructions may transform the CPU 1102 by specifying how the CPU 1102 transitions between states, thereby transforming the transistors or other discrete hardware elements constituting the CPU 1102.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1100 in order to store and execute the software components presented herein. It also should be appreciated that the computer architecture 1100 may include other types of computing devices, including hand-held computers, embedded computer systems, personal digital assistants, and other types of computing devices known to those skilled in the art. It is also contemplated that the computer architecture 1100 may not include all of the components shown in FIG. 11, may include other components that are not explicitly shown in FIG. 11, or may utilize an architecture completely different than that shown in FIG. 11.

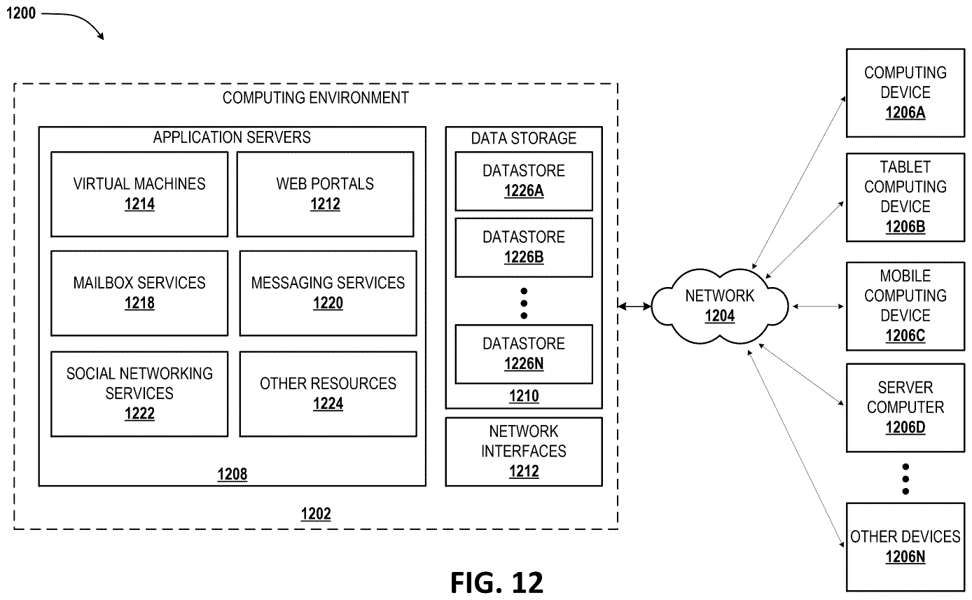

FIG. 12 depicts an illustrative distributed computing environment 1200 capable of executing the software components described herein for providing contextually-aware insights and data. Thus, the distributed computing environment 1200 illustrated in FIG. 12 can be utilized to execute any aspects of the software components presented herein. For example, the distributed computing environment 1200 can be utilized to execute aspects of the software components described herein.

According to various implementations, the distributed computing environment 1200 includes a computing environment 1202 operating on, in communication with, or as part of the network 1204. The network 1204 may be or may include the network 1204, described above. The network 1204 also can include various access networks. One or more client devices 1206A-1206N (hereinafter referred to collectively and/or generically as “clients 1206”) can communicate with the computing environment 1202 via the network 1204 and/or other connections (not illustrated in FIG. 12). In one illustrated configuration, the clients 1206 include a computing device 1206A such as a laptop computer, a desktop computer, or other computing device; a slate or tablet computing device (“tablet computing device”) 1206B; a mobile computing device 1206C such as a mobile telephone, a smart phone, or other mobile computing device; a server computer 1206D; and/or other devices 1206N. It should be understood that any number of clients 1206 can communicate with the computing environment 1202. Two example computing architectures for the clients 1206 are illustrated and described herein with reference to FIGS. 1-12. It should be understood that the illustrated clients 1206 and computing architectures illustrated and described herein are illustrative, and should not be construed as being limited in any way.

In the illustrated configuration, the computing environment 1202 includes application servers 1208, data storage 1210, and one or more network interfaces 1212. According to various implementations, the functionality of the application servers 1208 can be provided by one or more server computers that are executing as part of, or in communication with, the network 1204. The application servers 1208 can host various services, virtual machines, portals, and/or other resources. In the illustrated configuration, the application servers 1208 host one or more virtual machines 1214 for hosting applications or other functionality. According to various implementations, the virtual machines 1214 host one or more applications and/or software modules for providing clustered data. It should be understood that this configuration is illustrative, and should not be construed as being limiting in any way. The application servers 1208 also host or provide access to one or more portals, link pages, Web sites, and/or other information (“Web portals”) 1212.

According to various implementations, the application servers 1208 also include one or more mailbox services 1218 and one or more messaging services 1220. The mailbox services 1218 can include electronic mail (“email”) services. The mailbox services 1218 also can include various personal information management (“PIM”) services including, but not limited to, calendar services, contact management services, collaboration services, and/or other services. The messaging services 1220 can include, but are not limited to, instant messaging services, chat services, forum services, and/or other communication services.

The application servers 1208 also may include one or more social networking services 1222. The social networking services 1222 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 1222 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 1222 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Washington. Other services are possible and are contemplated.

The social networking services 1222 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 1222 are not mentioned herein for the sake of brevity. As such, the above configurations are illustrative, and should not be construed as being limited in any way. According to various implementations, the social networking services 1222 may host one or more applications and/or software modules for providing the functionality described herein for providing data clustering. For instance, any one of the application servers 1208 may communicate or facilitate the functionality and features described herein. For instance, a social networking application, mail client, messaging client or a browser running on a phone or any other client 1206 may communicate with a networking service 1222 and facilitate the functionality, even in part, described above with respect to FIGS. 1-12.

As shown in FIG. 12, the application servers 1208 also can host other services, applications, portals, and/or other resources (“other resources”) 1224. The other resources 1224 can include, but are not limited to, document sharing, rendering or any other functionality. It thus can be appreciated that the computing environment 1202 can provide integration of the concepts and technologies disclosed herein provided herein with various mailbox, messaging, social networking, and/or other services or resources.

As mentioned above, the computing environment 1202 can include the data storage 1210. According to various implementations, the functionality of the data storage 1210 is provided by one or more databases operating on, or in communication with, the network 1204. The functionality of the data storage 1210 also can be provided by one or more server computers configured to host data for the computing environment 1202. The data storage 1210 can include, host, or provide one or more real or virtual data stores 1226A-1226N (hereinafter referred to collectively and/or generically as “datastores 1226”). The datastores 1226 are configured to host data used or created by the application servers 1208 and/or other data. Although not illustrated in FIG. 12, the datastores 1226 also can host or store web page documents, word documents, presentation documents, data structures, algorithms for execution by a recommendation engine, and/or other data utilized by any application program or another module. Aspects of the datastores 1226 may be associated with a service for storing files.

The computing environment 1202 can communicate with, or be accessed by, the network interfaces 1212. The network interfaces 1212 can include various types of network hardware and software for supporting communications between two or more computing devices including, but not limited to, the clients 1206 and the application servers 1208. It should be appreciated that the network interfaces 1212 also may be utilized to connect to other types of networks and/or computer systems.

It should be understood that the distributed computing environment 1200 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1200 provides the software functionality described herein as a service to the clients 1206. It should be understood that the clients 1206 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 1200 to utilize the functionality described herein for providing data clustering, among other aspects.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

It is to be appreciated that conditional language used herein such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

It should be also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Among many other technical benefits, the technologies herein enable more efficient use of computing resources such as processor cycles, memory, network bandwidth, and power, as compared to previous solutions relying upon inefficient manual placement of virtual objects in a 3D environment. These techniques offer significant benefits, including the ability to effectively handle unstructured data, and enhanced efficiency in clustering results.

Other technical benefits not specifically mentioned herein can also be realized through implementations of the disclosed subject matter.

Although the techniques have been described in language specific to structural features and/or methodological acts, it is to be understood that the appended claims are not necessarily limited to the features or acts described. Rather, the features and acts are described as example implementations of such techniques.

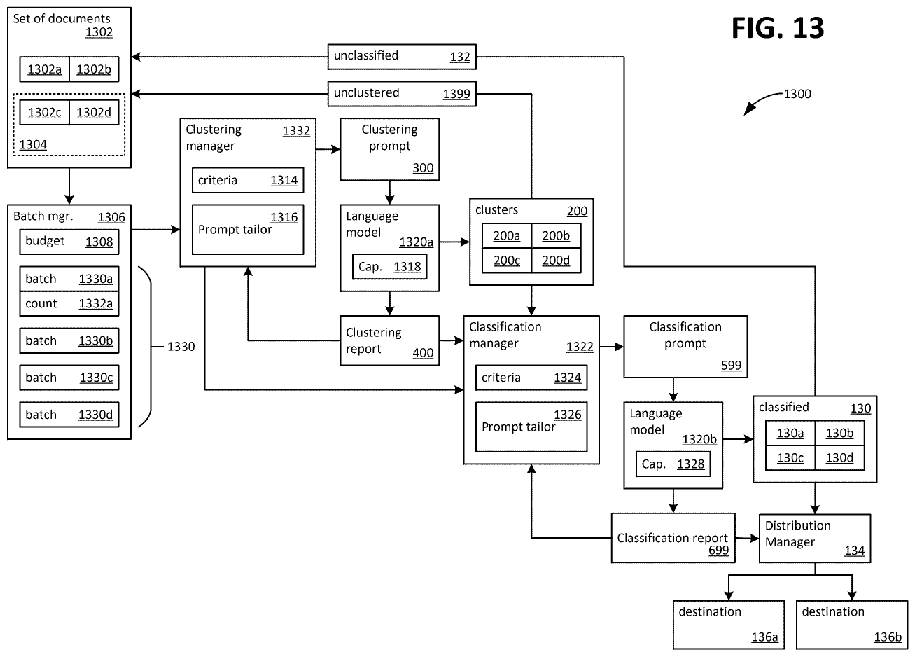

FIG. 13 illustrates an example architecture 1300 that performs dataset clustering and evaluation for a set of documents 1302 that includes documents 1302a-1302d. In some examples, set of documents 1302 comprises a plurality of website feedback documents. In some examples, set of documents 1302 is processed in batches, and a pool of documents 1304 comprises those documents of set of documents 1302 that are still awaiting processing. Initially, pool of documents 1304 may include all of set of documents 1302, and pool of documents 1304 shrinks as documents are processed. For example, documents 1302a and 1302b are shown as having already been processed, whereas documents 1302c and 1302d are still within pool of documents 1304 awaiting processing.

When set of documents 1302 is large enough that attempting to cluster or classify the entirety of set of documents 1302 all at once would overload the language model(s) being used, batch manager 1306 batches set of documents 1302 into batches of documents 1330. As illustrated, a language model 1320a is used for clustering and a language model 1320b is used for classification. In some examples, a single language model is used for both clustering and classification. Language models 1320a and 1320b may comprise an MM and/or an LLM. Example LLMs that may be used include generative pre-trained transformers (GPTs), such as GPT-3, GPT-3.5, GPT-4, and later GPTs.

Batch manager 1306 identifies a context token capacity 1318 of language model 1320a and uses it to determine a context token budget 1308 for batching, and generates batches that allow room for output results, and will not overwhelm language model 1320a. During the classification phase, batch manager 1306 identifies a context token capacity 1328 of language model 1320b and uses it to adjust context token budget 1308 for batching (if necessary), so that language model 1320b is not overwhelmed. This way, a clustering prompt 300, which is used to instruct language model 1320a to perform clustering, will not exceed the capacity of language model 1320a, and a classification prompt 599, which is used to instruct language model 1320b to perform classification, will not exceed the capacity of language model 1320b.

Four batches of documents are illustrated, although the number of batches may be different, in some examples. A batch 1330a, which is also referred to as portion 1330a of set of documents 1302, is shown, along with a batch 1330b, a batch 1330c, and a batch 1330d. In an example, portion 1330a and batch 1330b are used for clustering. Without batching, portion 1330a may be the entire group of documents used for clustering. Also illustrated is a count of context tokens 1332a for portion 1330a, although it should be understood that a count of context tokens also exists for other batches of documents 1330, indicating the count of tokens within each of the other batches.

A clustering manager 1332 manages clustering by language model 1320a until clustering stopping criteria 1314 is met. In some examples, clustering stopping criteria 1314 comprises a threshold percentage of a current portion of set of documents 1302 being clustered, such as 20 percent or 30 percent, or another percentage. In some examples, other criteria may be used, such as a maximum count of topics. Clustering manager 1332 has a cluster prompt tailor 1316 that tailors clustering prompt 300 for each iteration of clustering (when batching is used).

Language model 1320a uses clustering prompt 300 to perform clustering, generating a clustering report 400, which may be in Java script object notation (JSON) or use a similar syntax, in some examples. Clustering report 400 identifies a plurality of clusters 200, which is shown as a separate element, but is a notional construct. In some examples, plurality of clusters 200 is hierarchical and/or permits overlap, such that a single document (e.g., document 1302a) may belong to two different clusters. In some examples, clustering prompt 300 may further specify whether plurality of clusters 200 is to be broad or narrow.

Plurality of clusters 200 is shown as having four clusters, a cluster 200a, a cluster 200b, a cluster 200c, and a cluster 200d, although it should be understood that a different count of clusters may be used in some examples. Any documents in the batch that are not clustered are within unclustered documents 1399, and returned to pool of documents 1304. When clustering is iterated, a different clustering prompt 300 is used each iteration, for example a clustering prompt 300a for the first iteration (portion 1330a), a clustering prompt 300b for the second iteration (batch 1330b), and so on. With each iteration of clustering, plurality of clusters 200 may grow.

Upon plurality of clusters 200 meeting clustering stopping criteria 1314, clustering manager 1332 alerts a classification manager 1322 to begin classification using plurality of clusters 200. Classification manager 1322 manages classification by language model 1320b until classification stopping criteria 1324 is met. In some examples, classification stopping criteria 1324 comprises a threshold percentage of set of documents 1302 being classified, such as 80 percent or 90 percent, or another percentage. In some examples, other criteria may be used, such as a maximum count of classified documents. Classification manager 1322 has a classification prompt tailor 1326 that tailors classification prompt 599 for each iteration of classification (when batching is used). An example of classification prompt 599 is shown in FIG. 5 and described below.

Language model 1320b uses classification prompt 599 to perform classification, generating a classification report 699, which may be in JSON or use a similar syntax, in some examples. Classification report 699 identifies a classified documents 130, which is shown as a separate element, but is a notional construct. Classified documents 130 includes a classified document 130a, a classified document 130b, a classified document 130c, and a classified document 130d, although it should be understood that a different count of classified documents 130 may be used in some examples. Classified documents 130a-130c represent any of documents 1302a-1302d. Any documents in the current batch that are not (yet) placed into classified documents 130 are instead within unclassified documents 130, and returned to pool of documents 1304. When classification is iterated, classification prompt 599 is updated with the current batch of documents, but retains plurality of clusters 200. With each iteration of classification, classified documents 130 may grow.

The disclosure presented herein also encompasses the subject matter set forth in the following clauses:

Clause 1: A computer-implemented method for classifying a dataset comprising text data into topics, the method comprising:
accessing a dataset to be classified into themes, the dataset comprising a plurality of text statements and the themes comprising a concept that characterizes a group of text data;
selecting a subset of the dataset;
using the subset, generating the themes using a language model;
classifying and labeling each item in the subset into the set of themes using the language model;
training a classifier model using the classified and labeled subset and the generated themes;
using the trained classifier model to classify the dataset into the set of themes; and
generating an output identifying which items of the dataset are classified into which themes of the set of themes.

Clause 2: The computer-implemented method of clause 1, wherein the classifier model is a binary classification model.

Clause 3: The computer-implemented method of any of clauses 1-2, further comprising inspecting cluster names and clustering results to determine fit, and labeling positive and negative examples to train the classifier model.

Clause 4: The computer-implemented method of any of clauses 1-3, further comprising applying sentiment analysis to the set of data.

Clause 5: The computer-implemented method of any of clauses 1-4, wherein classifying each item in the subset comprises:
performing unsupervised clustering;
generating initial clusters;
adjusting a sensitivity slider;
finalizing the initial clusters based on an inspection of the initial clusters; and
labeling the finalized clusters.

Clause 6: The computer-implemented method of any of clauses 1-5, wherein outliers in the dataset are adjusted into desired clusters.

Clause 7: The computer-implemented method of clauses 1-6, further comprising: collecting additional verbatim during a predetermined amount of time;
for each new verbatim:
   place the new verbatim into original named clusters;
   dynamically adjust cluster parameters without a full retrain of the classifier; and
   performing visualization, trending, and new topic detection.

Clause 8: A system comprising:
one or more data processing units; and
a computer-readable medium having encoded thereon computer-executable instructions to cause the one or more data processing units to perform operations comprising:
accessing a set of data to be classified into themes, the set of data comprising a plurality of text statements and the themes comprising a concept that characterizes a group of similar text data;
selecting a subset of the set of data;
using the subset, generating the themes using a first language model;
classifying each item in the subset into the set of themes using the first language model;
using the classified subset and the generated themes as a training set for a classifier model;
using the trained classifier model to classify the set of data into the set of themes; and
generating an output identifying which items of the set of data are classified into which themes of the set of themes.

Clause 9: The system of clause 8, wherein the classifier model is a binary classification model.

Clause 10: The system of any of clauses 8 and 9, further comprising computer-executable instructions to cause the one or more data processing units to perform operations comprising inspecting cluster names and clustering results to determine fit, and labeling positive and negative examples to train the classifier model.

Clause 11: The system of any of clauses 8-10, further comprising computer-executable instructions to cause the one or more data processing units to perform operations comprising applying sentiment analysis to the set of data.

Clause 12: The system of any of clauses 8-11, wherein classifying each item in the subset comprises:
performing unsupervised clustering;
generating initial clusters;
adjusting a sensitivity slider;
finalizing the initial clusters based on an inspection of the initial clusters; and
labeling the finalized clusters.

Clause 13: The system of any of clauses 8-12, wherein outliers in the dataset are adjusted into desired clusters.

Clause 14: The computer system of any of clauses 8-13, further comprising computer-executable instructions to cause the one or more data processing units to perform operations comprising:
collecting additional verbatim during a predetermined amount of time;
for each new verbatim:
   place the new verbatim into original named clusters;
   dynamically adjust cluster parameters without a full retrain of the classifier; and
   performing visualization, trending, and new topic detection.

Clause 15: A system comprising:
means for accessing a set of data to be classified into themes, the set of data comprising a plurality of text statements and the themes comprising a concept that characterizes a group of similar text data;
means for selecting a subset of the set of data;
means for using the subset, generating the themes using a first language model;
means for classifying each item in the subset into the set of themes using the first language model;
means for using the classified subset and the generated themes as a training set for a classifier model;
means for using the trained classifier model to classify the set of data into the set of themes; and
means for generating an output identifying which items of the set of data are classified into which themes of the set of themes.

Clause 16: The system of clause 15, wherein the classifier model is a binary classification model.

Clause 17: The system of any of clauses 15 and 16, further comprising means for inspecting cluster names and clustering results to determine fit, and labeling positive and negative examples to train the classifier model.

Clause 18: The system of any of clauses 15-17, further comprising means for applying sentiment analysis to the set of data.

Clause 19: The system of any of clauses 15-18, wherein classifying each item in the subset further comprises:
performing unsupervised clustering;
generating initial clusters;
adjusting a sensitivity slider;
finalizing the initial clusters based on an inspection of the initial clusters; and
labeling the finalized clusters.

Clause 20: The system of any of clauses 15-19, wherein outliers in the dataset are adjusted into desired clusters.

What is claimed is:

1. A computer-implemented method for classifying a dataset comprising text data into topics, the method comprising:
accessing a dataset to be classified into themes, the dataset comprising a plurality of text statements and the themes comprising a concept that characterizes a group of text data;
selecting a subset of the dataset;
using the subset, generating a set of themes using a language model;
classifying and labeling each item in the subset into the set of themes using the language model;
training a classifier model using the classified and labeled subset and the generated set of themes;
using the trained classifier model to classify the dataset into the themes; and
generating an output identifying which items of the dataset are classified into which themes of the set of themes.

2. The computer-implemented method of claim 1, wherein the classifier model is a binary classification model.

3. The computer-implemented method of claim 1, further comprising inspecting cluster names and clustering results to determine fit, and labeling positive and negative examples to train the classifier model.

4. The computer-implemented method of claim 1, further comprising applying sentiment analysis to the set of data.

5. The computer-implemented method of claim 1, wherein classifying each item in the subset comprises:
performing unsupervised clustering;
generating initial clusters;
adjusting a sensitivity slider;
finalizing the initial clusters based on an inspection of the initial clusters; and
labeling the finalized clusters.

6. The computer-implemented method of claim 5, wherein outliers in the dataset are adjusted into desired clusters.

7. The computer-implemented method of claim 1, further comprising:
collecting additional verbatim during a predetermined amount of time;
for each new verbatim:
place the new verbatim into original named clusters;
dynamically adjust cluster parameters without a full retrain of the classifier; and
performing visualization, trending, and new topic detection.

8. A system comprising:
one or more data processing units; and
a computer-readable medium having encoded thereon computer-executable instructions to cause the one or more data processing units to perform operations comprising:
accessing a set of data to be classified into themes, the set of data comprising a plurality of text statements and the themes comprising a concept that characterizes a group of similar text data;
selecting a subset of the set of data;
using the subset, generating the themes using a first language model;
classifying each item in the subset into the set of themes using the first language model;
using the classified subset and the generated themes as a training set for a classifier model;
using the trained classifier model to classify the set of data into the set of themes; and
generating an output identifying which items of the set of data are classified into which themes of the set of themes.

9. The system of claim 8, wherein the classifier model is a binary classification model.

10. The system of claim 8, further comprising computer-executable instructions to cause the one or more data processing units to perform operations comprising inspecting cluster names and clustering results to determine fit, and labeling positive and negative examples to train the classifier model.

11. The system of claim 8, further comprising computer-executable instructions to cause the one or more data processing units to perform operations comprising applying sentiment analysis to the set of data.

12. The system of claim 8, wherein classifying each item in the subset comprises:
performing unsupervised clustering;
generating initial clusters;
adjusting a sensitivity slider;
finalizing the initial clusters based on an inspection of the initial clusters; and
labeling the finalized clusters.

13. The system of claim 12, wherein outliers in the dataset are adjusted into desired clusters.

14. The system of claim 8, further comprising computer-executable instructions to cause the one or more data processing units to perform operations comprising:
collecting additional verbatim during a predetermined amount of time;
for each new verbatim:
place the new verbatim into original named clusters;
dynamically adjust cluster parameters without a full retrain of the classifier; and
performing visualization, trending, and new topic detection.

15. A system comprising:
means for accessing a set of data to be classified into themes, the set of data comprising a plurality of text statements and the themes comprising a concept that characterizes a group of similar text data;
means for selecting a subset of the set of data;
means for using the subset, generating the themes using a first language model;
means for classifying each item in the subset into the set of themes using the first language model;
means for using the classified subset and the generated themes as a training set for a classifier model;
means for using the trained classifier model to classify the set of data into the set of themes; and
means for generating an output identifying which items of the set of data are classified into which themes of the set of themes.

16. The system of claim 15, wherein the classifier model is a binary classification model.

17. The system of claim 15, further comprising means for inspecting cluster names and clustering results to determine fit, and labeling positive and negative examples to train the classifier model.

18. The system of claim 8, further comprising means for applying sentiment analysis to the set of data.

19. The system of claim 8, wherein classifying each item in the subset further comprises:
performing unsupervised clustering;
generating initial clusters;
adjusting a sensitivity slider;
finalizing the initial clusters based on an inspection of the initial clusters; and
labeling the finalized clusters.

20. The system of claim 19, wherein outliers in the dataset are adjusted into desired clusters.
